(19) United States
(12) Patent Application Publication
(10) Pub. No.: US 2004/0136680 A1
(43) Pub. Date: Jul. 15, 2004

(54) Single layer MEMS based variable optical attenuator with transparent shutter

(75) Inventors: Moshe Medina, Haifa (IL); David Schreiber, Tel-Aviv (IL); David Kin, Tel-Aviv (IL); Boris Glushko, Ashdod (IL); Slava Krylov, Holon (IL); Eliezer Ben-Gad, (US)

Correspondence Address: DR. MARK FRIEDMAN LTD., C/o Bill Polkinghorn, Discovery Dispatch, 9003 Florin Way, Upper Malboro, MD, 20772, US

(73) Assignee: TERAOP LTD.

(21) Appl. No.: 10/750,760

(22) Filed: Jan. 5, 2004

Related U.S. Application Data
(60) Provisional application No. 60/438,578, filed on Jan. 9, 2003.
(60) Provisional application No. 60/500,335, filed on Sep. 5, 2003.

(51) Int. Cl. G02B 6/00

(52) U.S. Cl. 385/140

(57) ABSTRACT

A MEMS variable optical attenuator (VOA) comprises at least one semitransparent refraction-mode shutter having a wedge shape and operative to attenuate an optical beam transmitted from a first optical fiber to a second optical fiber using refraction of the beam, and an actuator operative to position the shutter in the path of the beam. Optionally, the VOA further comprises a locking mechanism for locking the shutter after actuation, and at least one damper connected to the shutter for shortening the VOA switching time. The actuator may include in various embodiments a folding suspension with straight or curved springs, some springs interacting electrostatically with one or more side electrodes to provide an essentially linear dependence of shutter movement on actuation voltage.

### CROSS REFERENCE TO RELATED APPLICATIONS

The present invention claims priority from U.S. Provisional Patent Applications No. 60/438,578, filed Jan. 9, 2003, and No. 60/500,335 filed Sep. 5, 2003.

### FIELD OF THE INVENTION

The present invention relates generally to optical attenuation, and more particularly, to methods and devices for MEMS-based variable attenuation of optical signals.

### BACKGROUND OF THE INVENTION

The wide application of variable optical attenuation of optical signals within optical communications networks insures that enhancements in variable optical attenuators (VOAs) and attenuation methods and capabilities can improve the field of optical network technology. Innovations that increase the performance qualities and lower the cost of manufacture of VOAs are also of value to communications technologists.

VOAs are indispensable components in a fiber optic network, in which they control the optical signal intensity before and after laser diodes, fiber optic amplifiers, and photodetectors. In particular, a large number of VOAs are needed in a wavelength division multiplexing (WDM) system, where the intensity of multiple channels of different wavelengths is individually controlled at the wavelength multiplexing (MUX) and demultiplexing (DEMUX) nodes. Most conventional VOAs comprise an assembly of a prism or a mirror driven by a solenoid coil or a motor. Despite excellent optical performance, existing VOAs do not fully satisfy the escalating demands of customers in terms of device size, power consumption, mechanical reliability and cost.

Several MEMS-based approaches have been proposed to miniaturize a VOA and make it faster. There are three typical architectures of MEMS VOAs. The first and most popular one is based on a dual fiber ferrule collimated by a graded index (GRIN) lens and reflected back by a rotating MEMS mirror, which attenuates the coupling between input and output fibers [U.S. Pat. No. 5,845,023; and H. Toshiyoshi et al., 12th International Conference on Solid State Sensors, Actuators and Microsystems, Boston, Jun. 8-12, 2003]. The second type is based on an electromechanically operated Fabry-Perot interferometer [J. E. Ford and J. A. Walker, “Dynamic Spectral Power Equalization Using Micro-Opto-Mechanics,” IEEE Photon. Tech. Lett., vol. 10, No. 10 (1998), pp. 1440-1449] which can control the attenuation level, but cannot achieve complete blockout (over 40 dB). The third type is the shutter insertion type [V. Aksyuk teal. “Electronics Letters, vol. 34, No. 14 (1998), pp. 1413; and U.S. Pat. No. 6,459,845], which has been shown to be easily integrated with surface/bulk micro machined actuators.

The first two types require utilization of costly optical elements, being therefore quite expensive. The shutter type VOA, which typically includes a pair of fibers closely placed in the same V-groove and a MEMS shutter inserted therebetween, reduces the cost and simplifies the performance. However, a shutter type VOA has its own disadvantages, e.g. highly nonlinear dependence of attenuation on shutter displacement and correspondingly on the applied voltage, and higher polarization dependent losses (PDL), due to polarization-dependent shutter sidewall scattering and beam edge diffraction. In addition, a shutter type VOA requires troublesome metal coating of the MEMS shutter sidewalls to block out the incident light, since a pure silicon shutter is completely transparent to 1.55 μm light. There are furthermore two general problems common to any MEMS type VOA: it is extremely difficult to reduce the shock/vibration impact on VOA performance, and it is extremely difficult to obtain the attenuation as a predetermined function of the applied actuation voltage.

Most recently, Y. H. Lee et al. in Optics Communication, 221, (2003), pp.323-330 (hereafter Lee 2003) proposed and analyzed a silicon wedge shutter in order to solve the sidewall coating problem and linearize the attenuation behavior. They suggested a triangular shape shutter designed to provide total internal reflection (TIR) of an input beam at the output sidewall of the shutter, thus achieving the required attenuation level (>40dB). However, the problem of high PDL and nonlinear attenuation behavior for such a shutter still remains.

There is therefore a widely recognized need for, and it would be highly advantageous to have a MEMS-type VOA that does not suffer from the problems and disadvantages mentioned above.

### SUMMARY OF THE INVENTION

According to the present invention there is provided a MEMS variable optical attenuator (VOA) comprising: at least one semitransparent refraction-mode shutter having a wedge shape and operative to attenuate an optical beam transmitted along an optical path from a first optical fiber to a second optical fiber using refraction of the beam; and an actuator operative to position the shutter to intersect the optical path.

According to one embodiment of the MEMS VOA of the present invention, the VOA further comprises at least one damper selected from the group consisting of a squeeze film damper, an impact damper, and a combination thereof, the damper connected to the shutter and used for shortening the VOA switching time through the shortening of the decay time of undesirable mechanical vibrations during switching.

According to another embodiment of the MEMS VOA of the present invention, the VOA further comprises a locking mechanism for locking the shutter in an arbitrary actuated position.

According to the present invention there is provided a variable optical attenuator comprising: a transparent silicon shutter having two, a first and a second, non-parallel shutter sidewalls, each sidewall having an arbitrary shape, the shutter operative to attenuate an optical beam transmitted in an optical path from a transmitting fiber having a transmitting optical axis and facing the first shutter sidewall, to a receiving fiber having a receiving optical axis and facing the second shutter sidewall, wherein the attenuation is based on a tilt induced by a variable angle between the two non-parallel shutter sidewalls, the variable angle dependent on a position of the shutter relative to the beam; and an actuating mechanism for placing the shutter in the beam path.

According to the present invention there is provided an integrated variable optical attenuator and 2×2 optical switch component comprising four tapered and angled optical fibers arranged as two transmitting and two receiving fibers in a butt-coupling setup, and a MEMS element operative to perform both switching and variable optical attenuation of an optical beam transmitted along an optical path between one of the transmitting fibers to one of the receiving fibers.

According to the present invention there is provided a MEMS VOA comprising: a shutter operative to attenuate an optical beam transmitted along an optical path from a first optical fiber to a second optical fiber; and an actuator operative to position the shutter to intersect the optical beam path, the actuator including a folded suspension having a plurality of straight, curved, bent or combination thereof of springs, with at least one of the springs connected to the shutter.

According to the present invention there is provided a MEMS VOA comprising: a shutter operative to attenuate an optical beam transmitted along an optical path from a first optical fiber to a second optical fiber; an actuator operative to position the shutter in the beam path, wherein the actuator includes a folded suspension having a plurality of springs, at least one of the springs connected to the shutter, and wherein the at least one spring is selected from the group consisting of a curved spring and a bent spring; and at least one side electrode interacting electrostatically with the frame to provide the actuator operativeness.

According to the present invention there is provided a MEMS VOA comprising: a shutter operative to attenuate an optical beam transmitted along an optical path from a first optical fiber to a second optical fiber; and a high resolution radial-to-linear actuator including at least one pre-curved spring and operative to translate a radial movement of the pre-curved spring beam into a much smaller movement that positions the shutter to intersect the optical path.

### BRIEF DESCRIPTION OF THE DRAWINGS

FIG. 1 shows in (a) an isometric view of one embodiment of a MEMS based VOA according to the present invention;

FIG. 2 shows in (a) a detailed view of a central section of the VOA of the present invention, and in (b) ray tracing of a beam through the VOA shutter;

FIG. 3 shows in detail a transparent trapezium shaped shutter of the present invention;

FIG. 4 shows a side view of a vertically shaped shutter according to the present invention;

FIG. 5 shows an embodiment of a VOA with a two-sided shutter;

FIG. 6 shows a novel 2×2 switch with integrated VOA according to the present invention;

FIG. 7 shows an embodiment of a VOA with an electrostatically driven actuating mechanism and an elastic suspension connected by a frame;

FIG. 8 shows an electrostatically driven actuating mechanism with an elastic suspension connected to a serpentine-shaped shutter;

FIG. 9 shows an embodiment of a VOA as in FIG. 7 having additional side electrodes;

FIG. 10 shows an embodiment of a VOA with two frame-driven actuating mechanisms driving two shutters from opposite sides;

FIG. 11 shows an embodiment of a VOA in which the actuating mechanism comprises additional offset comb drives located on the frame;

FIG. 12 shows the principle of operation of the offset comb drives in the embodiment of FIG. 11;

FIG. 13 shows an embodiment of a VOA with an electrostatically driven actuating mechanism in which an elastic suspension incorporates pre-curved springs;

FIG. 14 shows an embodiment of a VOA as in FIG. 13 with additional offset comb drives;

FIG. 15 shows an embodiment of a VOA with a comb drive actuator with squeeze film and/or impact dampers;

FIG. 16 shows a lock mechanism for VOA according to the present invention: a) both mechanism and VOA un-actuated; b) mechanism pulled and VOA un-actuated; c) mechanism pulled and VOA in actuated-unlocked state; d) mechanism in un-actuated and locked VOA state; and e) mechanism in un-actuated VOA state-detailed view;

FIG. 17 shows a high resolution radial-to-linear (RTL) actuator for VOA according to the present invention: a) single curved spring RTL VOA actuator; b) slider single spring RTL actuator; c) double spring RTL actuator; d) enhanced central electrode RTL actuator; e) four element RTL actuator; f) four element plus enhanced central electrode RTL actuator; g) double shutter RTL actuator; h) as in (a) but with a bent spring instead of the curved spring.

### DETAILED DESCRIPTION OF THE PREFERRED EMBODIMENTS

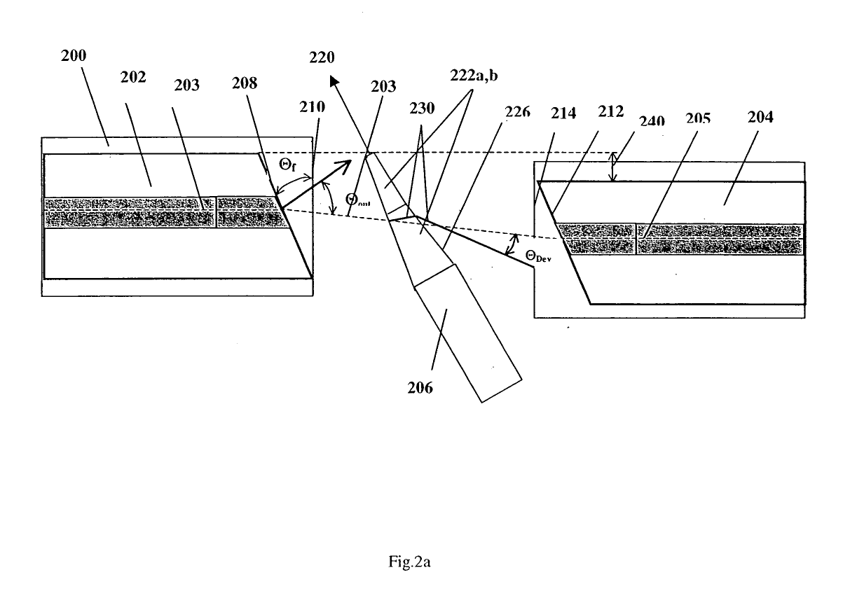

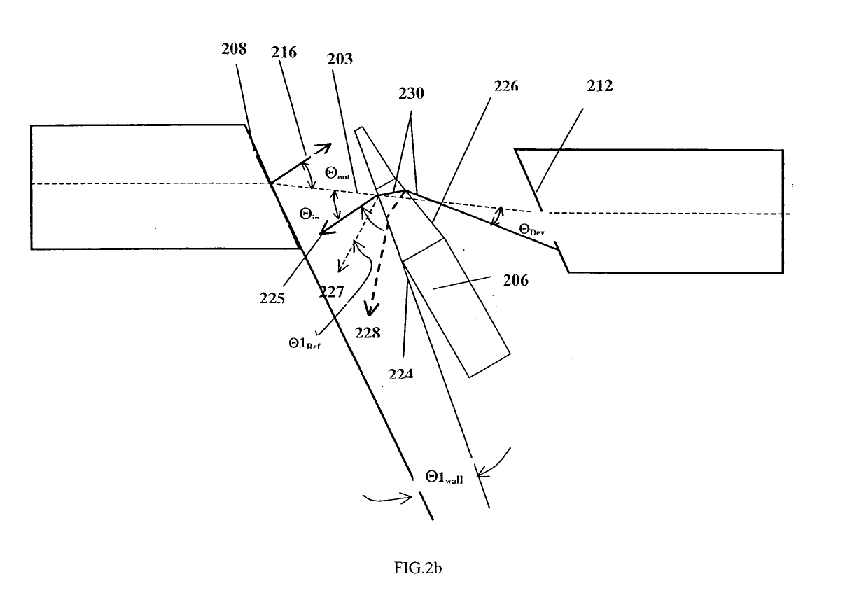

The present invention discloses, in various embodiments, a MEMS VOA comprising a silicon shutter shaped as a wedge that provides variable tilt for an output beam, and therefore variable attenuation. Other parameters such as polarization dependent losses (PDL), optical reflection losses (ORL) and wavelength dependent losses (WDL) are also a function of the shutter geometry. The shutter shape is preferably imparted by a combination of trapezium sections, as shown in more detail in FIG. 2. This particular shutter shape and geometry yield a VOA with a wide range of desirable parameters. In contrast with the shutter of Lee 2003, the shutter of the present invention does not operate in a total internal reflection mode or regime. With Lee's shutter, light impinging on the shutter is reflected inside the shutter body by total internal reflection (TIR), the shutter acting as a blocking unit as usual with reflecting, coated shutters. In contrast, the shutter of the present invention has a very small wedge angle and does not provide TIR, but only beam refraction or tilt that depend on the shutter design. Thus, the shutter of the present invention may be referred to as a “semitransparent refraction-mode shutter”.

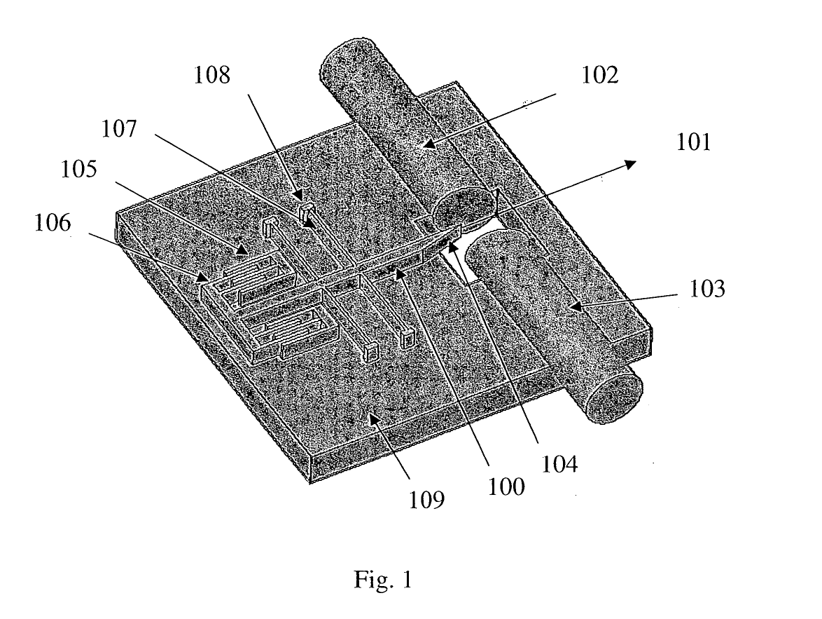

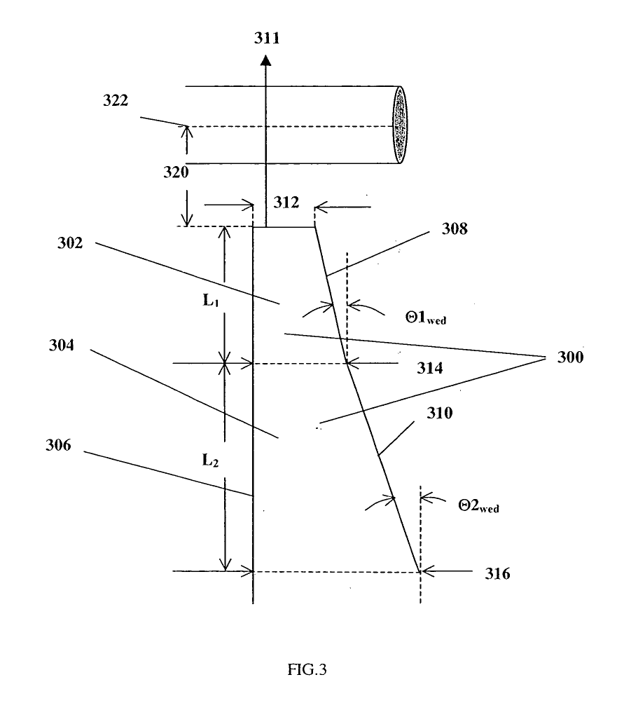

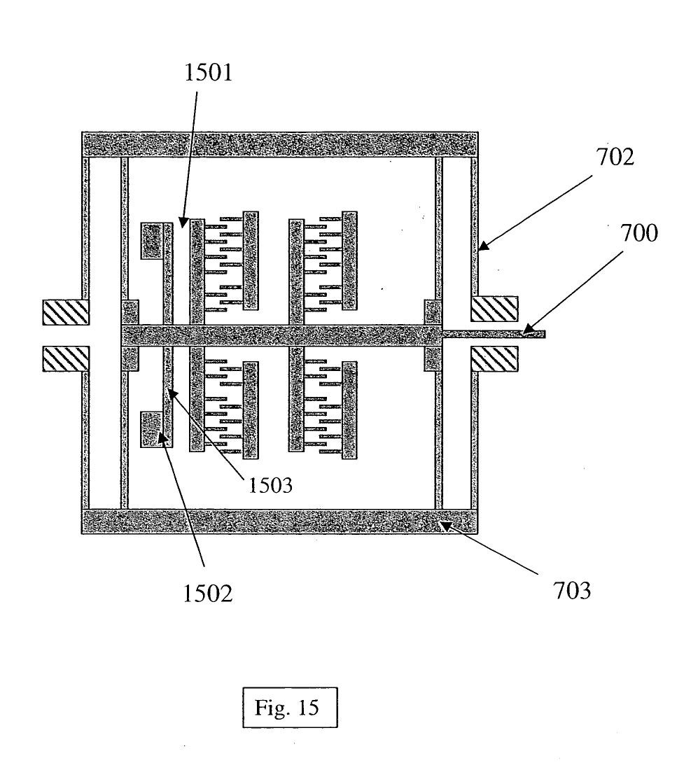

FIG. 1a shows an isometric view of a basic embodiment of a VOA according to the present invention, preferably implemented in a silicon-on-insulator (SOI) substrate comprising an active (top) silicon layer and a handle (bottom) silicon layer. Since the entire VOA is formed in the active layer, it is referred to as a “single layer” VOA. The VOA comprises a semitransparent refraction-mode silicon shutter 100 positioned and rendered operative to move along a motion axis 101 by an actuating mechanism (actuator), preferably a comb drive actuator with a stationary side 105 and a moving side 106. Optionally, as discussed in ore detail re. FIG. 15, the actuating mechanism further includes dampers (retaining springs) 107 fixed at one end 108 to the substrate. The positioning and movement of shutter 100 cuts an optical path between two optical fibers 102 and 103. In a preferred embodiment shown in more detail in FIGS. 2 and 3, the fibers are angled vs. the shutter motion axis. The shutter has a specially designed tip 104 with a shape to be described in detail below. Fibers 102 and 103 are preferably positioned in V-grooves etched in the handle layer of substrate 109. The comb drive and the shutter are built in the active layer. The processes used for fabricating the VOA include standard MEMS processes such as photolithography, wet or dry etching, metal depositions, etc., all of which are well known in the art.

FIG. 2 shows in (a) a detailed view of a central section 200 of the VOA of FIG. 1, and in (b) ray tracing of a beam through the VOA shutter. A central section 200 of the VOA shown in (a) comprises two fibers with angled faceted ends (“angled fibers”), an input (transmitting) fiber 202 with an optical axis 203 and an output (receiving) fiber 204 with an optical axis 205, the two fibers positioned on both sides of a shutter 206. In the preferred embodiment of FIG. 2a, the V-grooves (and the fibers) are shifted relative to each other, the two fibers thus not sharing a common length axis. Each fiber has an end facet cut at preferably an angle Θ_{f} of about 8° to a normal end face. Note that in all figures, the angles are not to scale. Thus fiber 202 has an end facet 208 at 8° to an end 210, and fiber 204 has an end facet 212 at 8° to an end 214. Both facets are polished and anti-reflection (AR) coated (at 1.55 μm wavelength) in order to prevent optical return losses (ORL). The light exiting transmitting fiber 202 experiences refraction at the “glass-air” border (axis 203 in air) and therefore has an angle of Θₒᵤₜ=Θ_{f} (n₂/n₁)=11.6°, (where n₁=1 (air) and n₂=1.44 (refractive index of glass)) with respect to a normal to fiber angled facet 216, and a tilt of Θₜᵢₗₜ=3.6° (Θₜᵢₗₜ=Θₒᵤₜ−Θ_{f}) with respect to axis 203.

Shutter 206 has a motion axis 220 that is preferably parallel to facets 208, 212, facilitating a reduction of the distance between the fibers to very small values, typically about 24 micron, thus reducing insertion loss (IL). The shutter has preferably a shape 222 imparted by use of trapezium sections (in this case two sections a and b). The shutter has a first flat sidewall 224, and a second sidewall 226 comprised of finite, preferably straight sections according to the various trapezium shapes. A more detailed structure of the shutter is shown in FIG. 3. This structure explains the “refraction and tilt” mode that differentiates the operating mode of this VOA from prior art, specifically Lee 2003 above.

Referring also to FIG. 2(b), the beam exiting the transmitting fiber is incident on first shutter sidewall 224, with an incidence angle Θ_{inc}=Θₒᵤₜ−Θ1_{wall}, with respect to a normal 225, where Θ1_{wall} is the flat sidewall angle with respect to the fiber angled facet plane. Reflected beam 227 experiences reflection from sidewall 224 (for example, the reflection value at the air-silicon interface is about 30%) at an angle Θ1_{Ref}=Θ_{inc}. The reflected beam returns to the entrance of the transmitting fiber exactly with the same angle. The first ORL signal is equal to the following expression.

ORL₁(dB)=−10*log(R_{Si}*exp(−(Θ_{inc}/Ω_{f})²)) (1)

where R_{Si}=0.3 is the Fresnel reflection at the air-silicon interface, and Ω_{f}=6° is the fiber numerical aperture or fiber acceptance angle. A second beam reflection 228 will occur at the second sidewall. The second reflected beam angle at the entrance of the transmitting fiber is

Θ2_{Ref}=Θ_{inc}+2Θ_{wed} (2)

where Θ_{wed} is a trapezium angle in the particular trapezium section that the beam passes through, FIG. 3. The second ORL signal at second shutter sidewall 226 is as follows

ORL₂=10*log(exp(−(Θ2_{Ref}/Ω_{f})^{2+(Θ2}_{Ref}Zₒ/2w_{f})²)) (3)

where w_{f} is the single mode fiber mode-field radius, and Zₒ is the distance between the transmitting and receiving fibers. The whole ORL signal from both sides of shutter, ORL_{SH} is

ORL_{SH}=−10*log(exp[−(Θ_{Dev}//Ω_{f})²−(Θ_{Dev}Zₒ/2w_{f})²]+exp[−(Θ2_{Ref/Ω}_{f})²−(Θ2_{Ref}Zₒ/2w_{f})²]) (4)

Part of the beam that passes through the shutter exits at the second sidewall as an exiting beam 230 with a deviation angle Θ_{Dev} with respect to axis 203 (un-deviated beam). This angle depends on many parameters, including the incident angle, the refractive index of silicon, and the beam center position with respect to the specific trapezium section the beam is passing through. For small wedge angles Θ_{wed}<10°, the deviation angle is simplified and depends only on the wedge angle and the refractive index difference between silicon and air:

Θ_{Dev}=Θ_{wed}(nₛᵢₗ−1) (5)

where nₛᵢₗ=3.48. The beam attenuation or coupling efficiency at the receiving fiber is now defined as follows (this expression is based on geometrical optics or ray tracing, and does not include diffraction phenomena):

Attn(Θ_{Dev})=−10*log[R_{Si}*exp−((Θ_{Dev}/Ω_{f})²+(Θ_{Dev}Zₒ/2w_{f})²))] (6)

where the first term in the exponent −(Θ_{Dev}/Ω_{f})² describes the normalized beam tilt and the second term −(Θ_{Dev}Zₒ/2w_{f})² is the normalized beam displacement at the receiving fiber, associated with beam tilt. Typically, w_{f}=5.25 μm, and Zₒ=24 μm. After passing the wedge, the different rays in the beam cross-section obtain different tilts and displacements, and therefore have different coupling efficiencies at the receiving fiber. By varying the shutter shape, size, the number of trapezium sections and their parameters, (e.g. height and trapezium angle) one can obtain almost any desired attenuation behavior vs. shutter displacement and, respectively, vs. applied actuation voltage. This is extremely important for different VOA applications, in which each may have a different spectrum of requirements, especially as related to the dependence of the attenuation function on applied voltage. For example, one application may require a linear dependence of attenuation on voltage in the range 0-20 dB, and a strongly exponential dependence between 20 and 45 dB. Another application may require a linear attenuation vs. voltage starting from 20 down to 0 dB (a so called “normally closed” VOA). There are applications restricting the applied voltage range to 5-10V. None of the existing VOA types (either rotating, or shutter type) is capable of satisfying such different requirements. The only VOA that can satisfy such requirements is the transparent silicon shutter with specially shaped sidewalls of the present invention, which is based on a desired beam ray refraction (in which each beam part may undergo different refractions) and which correspondingly may controllably provide predetermined attenuation vs. shutter displacement and voltage.

Due to the output beam deviation, the beam reaches the receiving fiber with a certain displacement 240, which depends on the distance between the fiber end facets and on the tilt angle. In order to compensate for this displacement, the receiving fiber V-groove is also displaced by the same value, for example 1.5 μm. In this case, only the distance between the two fibers determines the coupling efficiency, as well as the IL. If the distance between fibers is less than the Gaussian beam Rayleigh range (in the case of a fiber mode, about 50 μm, with the field diameter D_{f}=2ωf=10 μm), the beam size remains almost unchanged.

As mentioned, the displaced V-grooves for fiber alignment, the shutter and the MEMS actuator are fabricated on the same SOI wafer. It is understood that the shutter of the present invention may have different sizes, thicknesses, shapes and coatings of the sidewalls. A preferred shutter design, showing some of these features in more detail, is shown in FIG. 3.

FIG. 3 shows a shutter 300 comprising two trapezium sections 302 and 304. Shutter 300 has a straight left (first) sidewall 306 with length L₁+L₂ shared by the two sections and a right (second) sidewall comprised of a top section 308 and a bottom section 310. The shutter is thus “asymmetric” vs. an axis 311 identical with the motion axis in FIG. 2a. Consequently, the left and right sidewalls are at asymmetric angles with respect to the transmitting and receiving fiber facets (see FIGS. 1, 2). The shutter (and section 302) has also a flat leading edge (top) 312. Section 302 has a bottom 314 (which is also the top of section 304). Section 304 has a bottom 316. In an exemplary embodiment of the shutter of FIG. 3, which is by no means limiting, first section bottom 312 is 3 μm wide, bottom 314 is 3.354 μm wide, L₁=6.6 μm, L₂=26.4 μm, Θ1_{wed}=2.2°, second section bottom 316 is 8 μm wide, and Θ2_{wed}=10.2°. An initial distance 320 between the shutter leading edge and a beam axis 322 is typically 10 μm. This exemplary shutter design advantageously provides an ORL>45 dB on both sides of the VOA (the signal may be inserted either at the input or at the output fiber), when the shutter is an OFF or ON position. Further, this shutter design provides linear attenuation vs. applied voltage in the 0-22 dB range, an IL of 0.8 dB, a PDL of 0.3-0.4 dB, extremely low temperature dependent losses (TDL) of about 0.3 dB, and wavelength dependent losses (WDL) of about 0.5 dB in a spectral range 1520-1620 nm. In addition, this design also provides symmetric bidirectional VOA operation.

The shutter provides operation for a normally closed (OFF) VOA if originally placed in a normally closed (OFF) position (in which top edge 312 is positioned about 20 μm above of exiting beam center). With no bias, the initial VOA attenuation is >45 dB, and with bias the attenuation may be reduced to the IL value.

Optical Model

The VOA attenuation via shutter displacement was calculated using the following assumptions: a single-mode fiber output beam with a Gaussian shape is intersected by the moving silicon shutter and is accepted by a receiving single-mode fiber. The light passing the shutter and reaching the receiving fiber experiences reflection at sidewalls, tilt due to passage through the wedged shutter, displacement and diffraction. The light intensity propagation and coupling efficiency were calculated using both Mathcad ray tracing and GLAD (Applied Optics Research Inc.) diffraction theory simulations. The calculations/simulations were performed for both a blocking shutter in the shape of a knife-edge having gold-coated sidewalls, and for the semitransparent refraction-mole, wedge-type shutter of the present invention (without sidewalls coating).

According to the diffraction theory (GLAD simulation) and the experiments, a whole VOA attenuation from 0 to 30 dB for a blocking type shutter requires a very short shutter displacement, typically 7-9 μm. Such a short working distance renders a blocking type VOA undesirably sensitive to the shutter displacement, especially for high attenuation values. In contrast and advantageously, use of the semitransparent refraction-mode shutter of the present invention increases the effective VOA working distance up to 25-30 μm, making the VOA much less sensitive to the displacement. Also according to the simulations, backed by measurements of the coupling efficiency between two closely placed fibers, the coupling without any optical elements between the fibers using the present VOA reaches about 85-90%, resulting in an IL of about 0.5-0.8 dB.

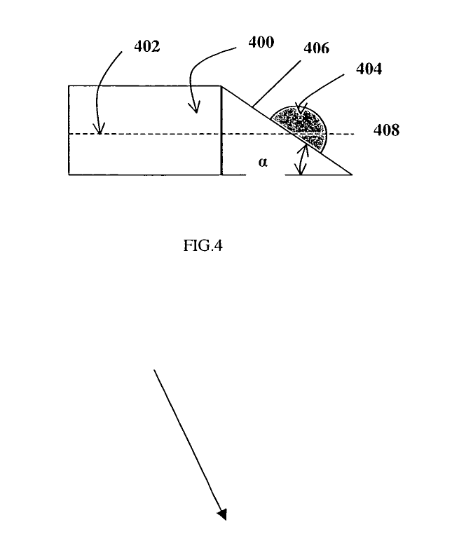

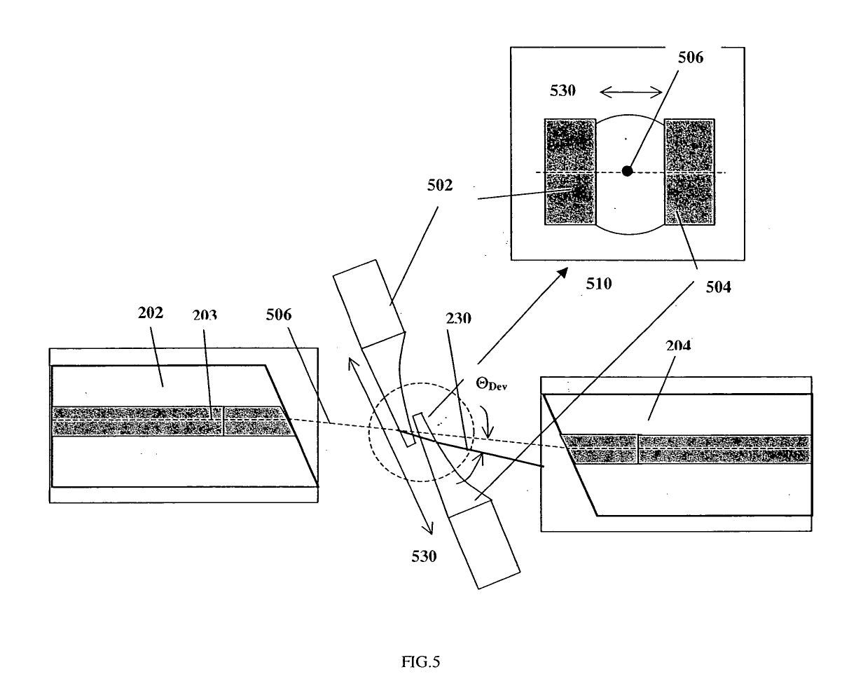

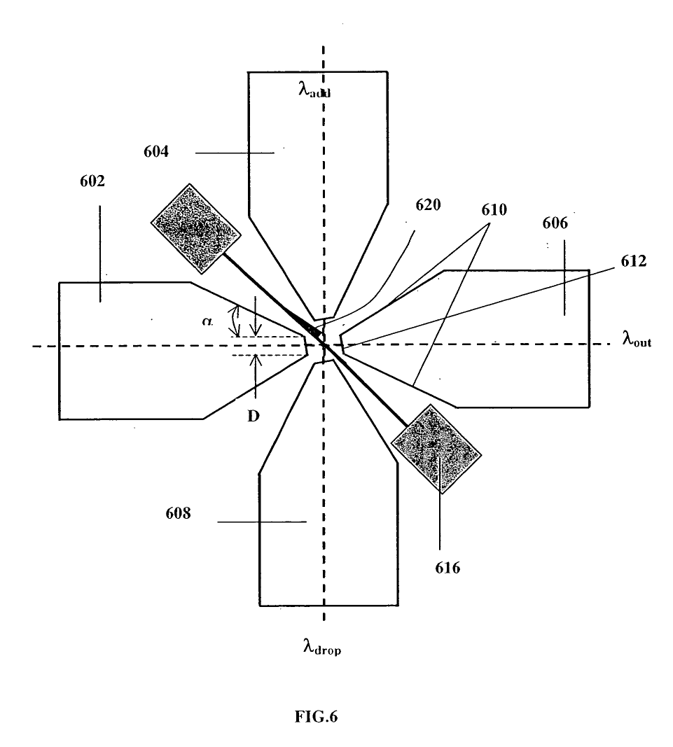

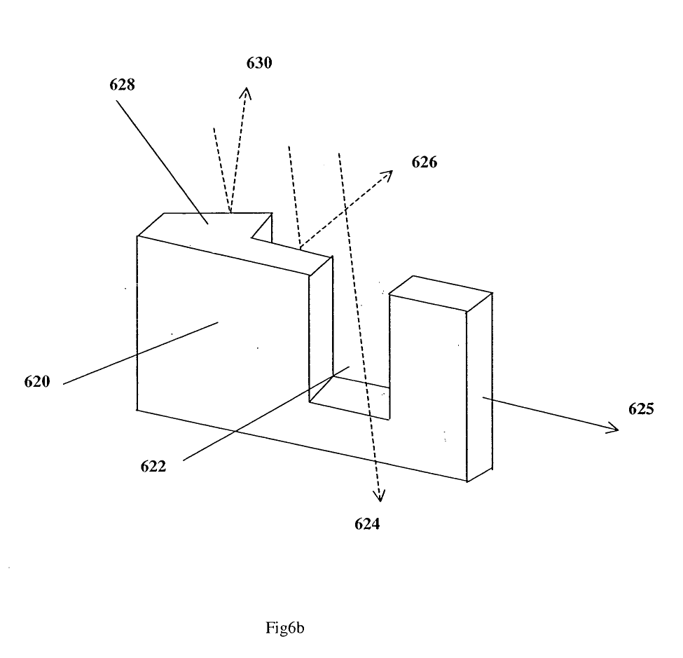

The VOA sensitivity to displacement may be further decreased, and the shutter effective working distance may be further increased by employing a yet another embodiment of the shutter, shown in FIG. 4. FIG. 4 shows a side view of a vertical triangularly shaped shutter 400 according to the present invention. The vertical shaping in the form of a shutter angled section (vertical wedge) 406 having an angle α in a plane orthogonal to an optical axis 402 of a beam 404. The figure also shows the position of the beam projection along the optical axis on angled section 406. The shutter in FIG. 4 moves horizontally (i.e. left-right) and cuts the beam optical axis using angled section 406. In this embodiment, the shutter has an angular shape in the vertical plane. The shutter working distance is increased in direct proportion to angle α and the maximum working distance may reach 25 μm for α=45°.

A known problem in the operation of all shutter type VOAs occurs when the device experiences vibrations and tilting A spring-handled shutter may be displaced laterally (orthogonal to its motion axis) due to vibrations, in which case the attenuation may have a value variation that can reach ±5 dB at 50 Hz vibration frequency (10 G acceleration). In order to overcome this problem, an embodiment of a VOA with two “opposing” shutters is shown in FIG. 5. The VOA in FIG. 5 comprises two shutters 502 and 504 with completely symmetric optical properties, positioned substantially on both sides of, at the same distance from a beam center (optical) axis 506. Under an applied actuating voltage, the two shutters move toward each other along an axis 530 and provide required attenuation (as in the case of one shutter). However, under the influence of gravitation or vibration, both shutters are displaced in the same direction simultaneously, along the same axis 530, orthogonal to beam center axis 506, (details of beam cross-section in a plane orthogonal to beam axis 506 are shown in an insertion 510), providing attenuation compensation (one shutter closes the beam and increases attenuation, while other shutter opens the beam and reduces attenuation exactly by the same value).

The two-shutter design may reduce the gravitation and vibration dependent attenuation variation from ±1 dB and ±5 dB down to ±0.1 and ±0.3 dB, respectively, even at a high attenuation level of 20 dB. Such a design also halves the displacement along the motion axis required from each shutter, which may substantially improve VOA operation stability, reliability and required voltage range.

2×2 Switch Design

FIG. 6 shows a novel 2×2 switch with integrated VOA according to the present invention. An integrated 2×2 optical switch/VOA structure is made possible by the special treatment of single mode fibers, without any additional optical elements. The figure shows a top view of the 2×2 optical switch that comprises four tapered and angled fibers 602, 604, 606 and 608 arranged in a butt-coupling setup. The four tapered fibers are grouped into two transmitting fibers (602 and 604) and two receiving fibers (606 and 608). All four fibers have identical tapered ends 610, each with a taper angle a of preferably about 40°. In addition, all tapered fibers are cut with an angled end facet 612 of about 8° (as in FIGS. 2, 3) to eliminate fiber facet ORL. The typical diameter of the angled fiber end facet is about 20 μm. This is a minimal taper angle, which allows reduction of the distance between fibers to 40-50 μm. At such distance, the insertion losses become small enough (<0.8 dB) to operate without any additional optical elements, such as lenses, lensed fibers, etc.

The switch further comprises a two-sided MEMS element 616, which acts both as a switching mirror and as a VOA shutter. The shutter is preferably a regular blocking type shutter, with a reflective coating on the sidewalls, with a triangular shutter shape operative to tilt a reflected beam out of a receiving fiber aperture. Two-sided MEMS element 616 includes a blocking type triangular shaped shutter 620 having a triangular section 628 (FIG. 6b) and positioned exactly symmetrically between the transmitting and receiving fibers. Shutter 620 also includes an opening 622, FIG. 6b, which allows free light propagation between a transmitting and a receiving fiber when properly aligned with the optical axis of the light beam.

In an “open” VOA position (defined by a non-blocking situation in which hole 622 is exactly aligned with the optical path of each transmitted beam), the light is transmitted directly from transmitting fibers 602 and 604 to receiving fibers 606 and 608 respectively. In this case, as shown in FIG. 6b, hole 622 allows free light propagation along an axis 624. When an actuating voltage is applied to the VOA, the shutter moves in a direction 625, crossing the light beams exiting from the transmitting fibers and redirecting them to the receiving fibers as follows: the beam from fiber 602 is directed to fiber 608, and the beam from fiber 604 is directed to fiber 606 as shown by axis 626, which coincides with the reflected beam direction. For high coupling efficiency, the shutter should preferably have flat, metal (e.g. gold)-coated sidewalls. Upon additional actuation, triangular shutter section 628 crosses beam 604 and tilts it out of receiving fiber 612, (the tilted beam shown by an arrow 630), the shutter thus acting as a VOA.

MEMS Structure Design

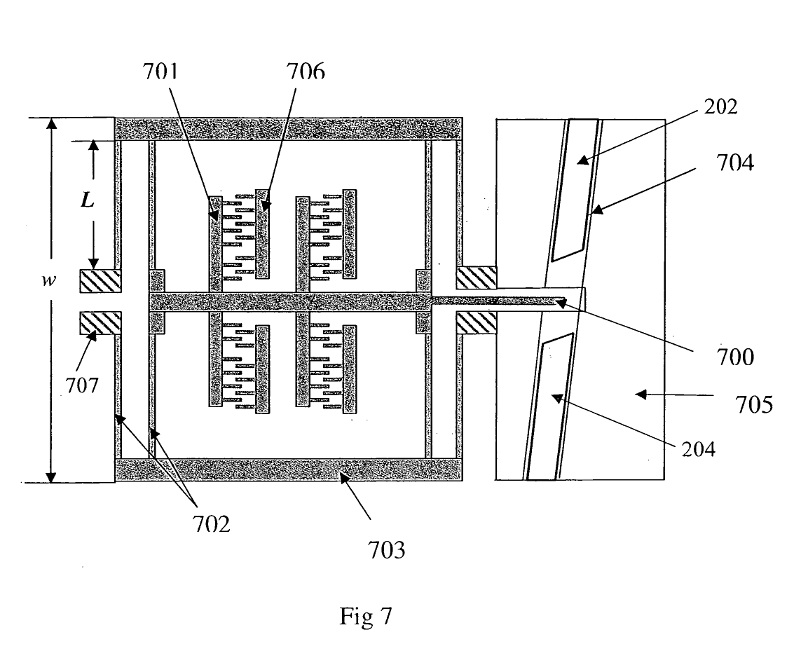

FIG. 7 shows an embodiment of an actuating mechanism that drives a shutter 700 to cut a beam in an optical path between two fibers 202 and 204 positioned in alignment trenches 704 etched in a substrate 705. Shutter 700 may be any shutter known in the art, preferably the semitransparent refraction-mode shutter described above. It is emphasized that the various embodiments of an actuating mechanism according to the present invention, as described in detail in FIGS. 7-17 and the description below, are equally applicable to other types of VOA shutters, specifically the blocking types known in the art. The embodiment of FIG. 7 includes an innovative frame design. The shutter is suspended above the substrate using eight springs 702. A suspension structure of this type is referred as folded suspension (e.g., see R. Legtenberg et al, “Comb-drive actuators for large displacements,” J. Micromech. Microeng. 6, pp. 320-329, 1996 (hereafter “Legtenberg 1996”)) and it is known to posess good mechanical linearity for a motion up to 10% of the spring length. In VOA applications, a relatively large number of combs 701 should be used to achieve low actuation voltage and small overall device width. This requires a longer shutter 700 well as two suspension points. If each of the suspensions is realized as a folded suspension, the total number of springs 702 would be 16. In our mechanism, a single folded suspension is built in such a way that one end of each suspension spring 702 is connected to frame 703, while the second end of suspension springs 702 is connected by anchors 707 to substrate 705. Some of these springs are connected to shutter 700. Shutter 700 is actuated electrostatically by movable combs 701 connected to the shutter, which interact with fixed combs 706 connected to the substrate.

The length of suspension springs 702 is defined based on two contradictory requirements. For low actuation voltage and stability of motion, the springs should be as long as possible. On the other hand, the maximal length L of springs 702 is limited by the total width of the device w such that 2L<w (see FIG. 7), and w is itself limited by requirements of optical fibers alignment. This limitation on w can be explained in the following way: for technological reasons, sections of transmitting (202) and receiving (204) fibers are suspended (like cantilevers) within the alignment trenches. The freestanding (suspended section) length is equal to w. When the freestanding length is large, the optical alignment between fibers is problematic because the freestanding fiber sections may bend. Decreasing the device width and therefore the fibers freestanding length improves the fibers alignment and leads to reduction in optical losses.

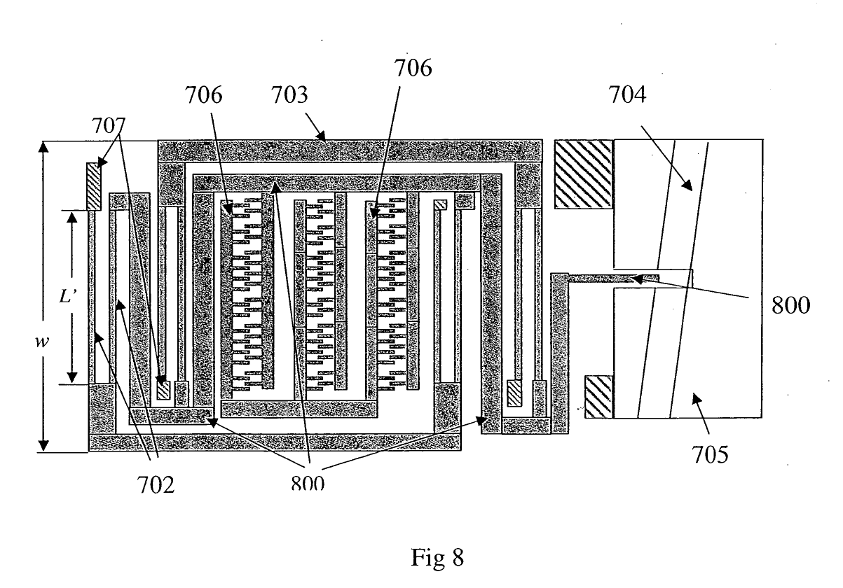

In the design shown in FIG. 7, all actuating elements, namely movable combs 701 and fixed combs 706 are located within the folded suspension in the area between suspension springs 702 and frame 703. This architecture, which uses 8 springs instead of 16, facilitates reduction of the actuation voltage or, alternatively, use of fewer combs 701 or shorter (and therefore stiffer) springs 702 for a specified actuation voltage. The use of shorter springs permits the reduction in the total width of the device, which is beneficial from an optical point of view. In addition, this architecture is described in detail, since it serves as basis for further design improvements, shown in FIGS. 8-15 and described below.

As mentioned, the minimal length of the suspension springs is limited by a “stability of motion” requirement. This requirement is explained below. It is well known that the stable traveling range of a comb drive actuator is limited by side instability. The maximally achievable displacement vₘₐₓ is given by the expression (Legtenberg 1996)

$${v}_{max} = {d}_{0} \sqrt{\frac{{k}_{x}}{2 {k}_{y}}} - \frac{{v}_{0}}{2} \qquad ( 7 )$$

where k_{y} is the suspension stiffness in the direction of the shutter motion and kₓ is the stiffness of the suspension in the deformed state in direction perpendicular to the shutter motion (lateral direction):

$${k}_{y} = \frac{24 EI}{{L}^{3}} \\ {k}_{x} ( v ) = \frac{200 EI}{3 {Lv}^{2}} {k}_{x}^{0} = \frac{2 EA}{L} \\ \frac{1}{{k}_{x}} = \frac{1}{{k}_{x}^{0}} + \frac{1}{{k}_{x} ( v )} \qquad ( 8 )$$

Here kₓ⁰ is the stiffness of the suspension in its initial un-deformed state in the lateral direction. These expressions suggest that the stable traveling range is proportional to the spring length L (FIG. 7), while the suspension stiffness (and therefore the square of the actuation voltage and/or number of combs) is proportional to L⁻³. From the stability viewpoint, it is beneficial to increase the spring length, while from the fiber alignment viewpoint, the opposite is desired. The stable range is proportional also to the electrostatic gap between combs, d₀. A larger gap permits a larger stable region but requires higher actuation voltage. We can conclude therefore that the improvement of the energetic effectiveness of the actuator is beneficial also from the stability point of view, since it allows a larger gap for the specified actuation voltage.

FIG. 8 shows yet another embodiment of an actuating mechanism connected to a serpentine like-shutter 800. In this design, in addition to frame 703 introduced in FIG. 7, anchors 707 are moved and shutter 800 is bent in such a way that the shutter, frame and springs form an interleaving compact structure. Here, in contrast with the design in FIG. 7 in which the total width of the device w is at least twice the length L of the springs 702, w can be close to the length L′ of the springs 702. This allows either to reduce the device width, thereby improving the optical alignment between the fibers, or alternatively, to increase L′ while w is preserved. As noted, the increase of the spring length is beneficial from the operating voltage and motion stability point of view (see Eqs. 7, 8). When the architecture with the serpentine-like shutter is implemented and the spring length is defined based on the actuation voltage and stability requirements, the width of the device is still small enough to satisfy the optical requirements.

To summarize, the designs presented in FIG. 7 and FIG. 8 facilitate the reduction in spring stiffness through the use of fewer springs or/and longer springs, while providing the required stable travel distance and keeping the device width within the range admissible from the optical point of view.

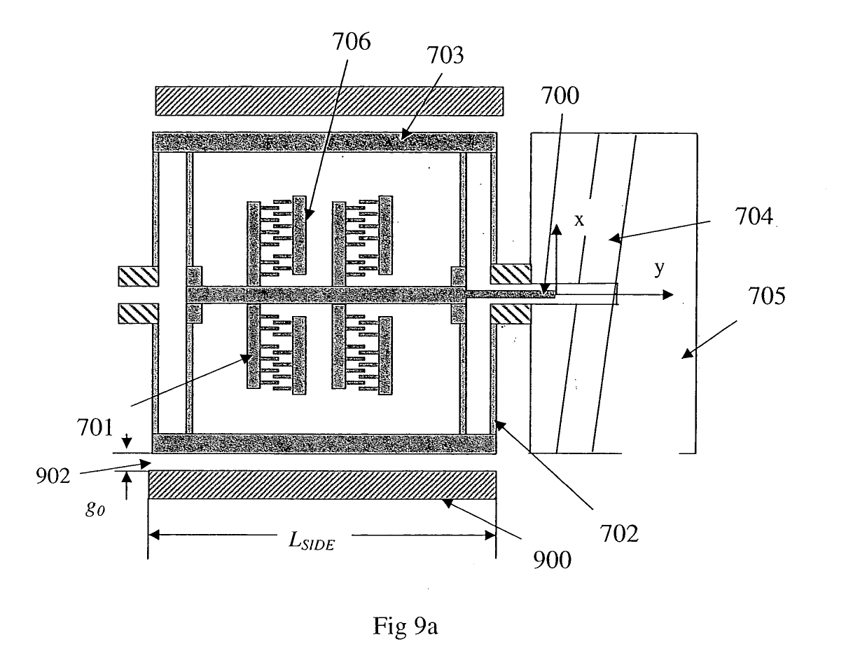

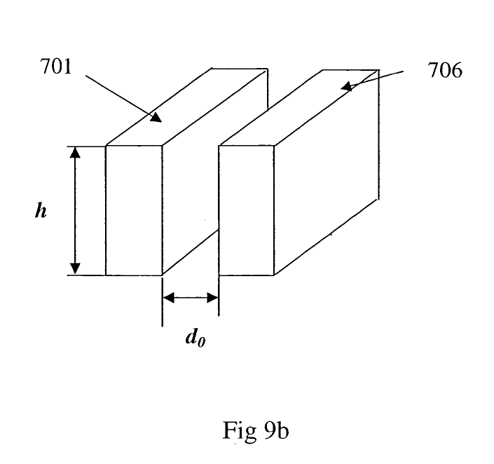

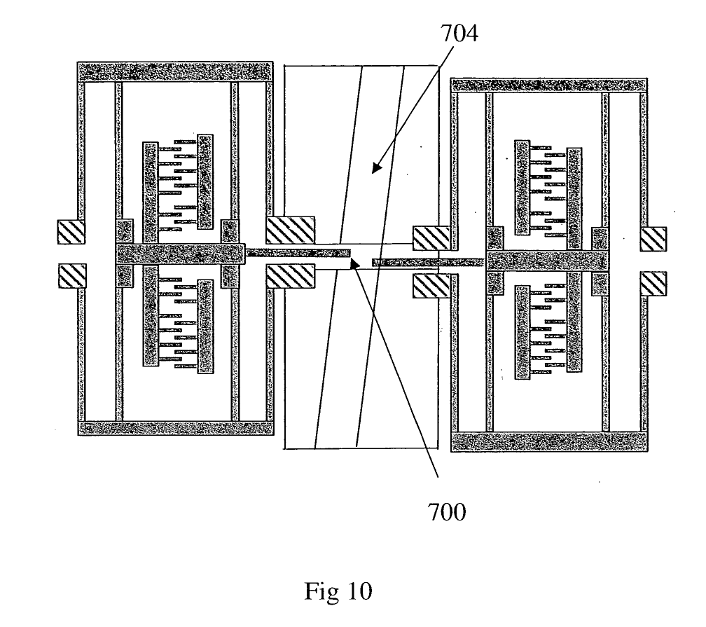

One of the requirements imposed on a MEMS based VOA is a rather uniform level of sensitivity for different levels of attenuation, i.e. a linear dependence between the actuation voltage and attenuation. However, electrostatically actuated devices usually exhibit nonlinear dependence between voltage and displacement. This is due to the fact that the mechanical restoring force is linear with displacement (constant stiffness k_{y} Eq. 7) while the electrostatic force depends on the square of the actuation voltage. A close to linear dependence between actuation voltage and shutter displacement or, alternatively, between voltage and attenuation, can be achieved by the active tuning of the mechanical stiffness of the springs. This tuning may be realized using a side electrode 900 shown in FIG. 9a, which applies a controllable electrostatic force on frame 703. The force is then transferred to springs 702 and allows the tuning of their stiffness through the coupling between the bending stiffness of the spring beam and the axial force acting along the spring beam. In the simplest case of an inextensible spring model, the displacement of the shutter Δ_{y} is given by the expression (see also Eq. 8)

$$( \frac{24 EI}{{L}^{3}} + \frac{24 {P}_{x}}{10 L} ) {Δ}_{y} = {F}_{COMB} \\ {\hat{Δ}}_{x} = - \frac{3}{5} \frac{{Δ}_{y}^{2}}{L} \qquad ( 9 )$$

where Δₓ is the contraction of the spring that results in the motion of frame 703 toward shutter 700, and where the forces produced by combs F_{COMB} and by the side electrode Pₓ are

$${P}_{x} = \frac{1}{8} {ϵ}_{0} \frac{{hL}_{SIDE} {V}_{SIDE}^{2}}{{( {g}_{0} - {Δ}_{x} )}^{2}} {F}_{COMB} = \frac{1}{4} \frac{N {ϵ}_{0} {hV}_{COMB}^{2}}{{d}_{0}} \qquad ( 10 )$$

g₀ is the width of an electrostatic gap 902 between side electrode 900 and frame 703, h is the thickness of the device perpendicular to the substrate (see FIG. 9b), N is the number of combs, L_{side} is the length of side electrode 900, and V_{SIDE} and V_{COMB} are actuation voltages applied to electrode 900 and comb drive 706 respectively. A nonlinear coupling between the axial force and shutter motion is observed, since the effective stiffness of the spring

$$( \frac{24 EI}{{L}^{3}} + \frac{24 {P}_{x}}{10 L} )$$

depends on the shutter displacement Δₓ through the axial force Pₓ (see Eqs. (8) and (9)). The separate operation of the side electrode and the comb drive can yield a close to linear dependence between the voltage and displacement, or between voltage and attenuation. The number of combs can be chosen in such a way that the linear dependence can be achieved by applying an equal actuation voltage to the comb drive and to the side electrode, i.e. using a single electrical channel. The actuator may also be operated in another mode, in which the voltage applied to the comb drive is kept constant while the side electrode voltage is changed. This mode allows interchanging between “normally open” and “normally closed” modes of operation without having to add comb drives that are normally needed for a “reverse” motion. In addition, tuning of the device frequency is possible if necessary. The application of an axial force to the spring increases the natural frequency of the device. The application of a voltage to the side electrode, combined with the release of the voltage applied to the combs, permits to decrease the switching time in a “normally closed” mode of the VOA when the shutter actuator has to be opened in a short time. Increase of the effective spring stiffness through the application of the voltage to the side electrode improves the device stability as follows from Eq. (6). This actuator is very effective energetically due to the small gap 902 between side electrode 901 and frame 703, and the resultant high actuation force provided by the side electrode.

FIG. 10 shows an embodiment of a VOA with two frame-driven actuating mechanisms driving two shutters from opposite sides. By using two opposing (facing each other) MEMS VOAs (shutters 700), the displacement necessary to block the light beam is halved, and the required actuating voltage is likewise decreased. The figure shows both shutters in a “normally closed” position, meaning that in their “off” state they block the beam. The attenuation then decreases with increasing voltage.

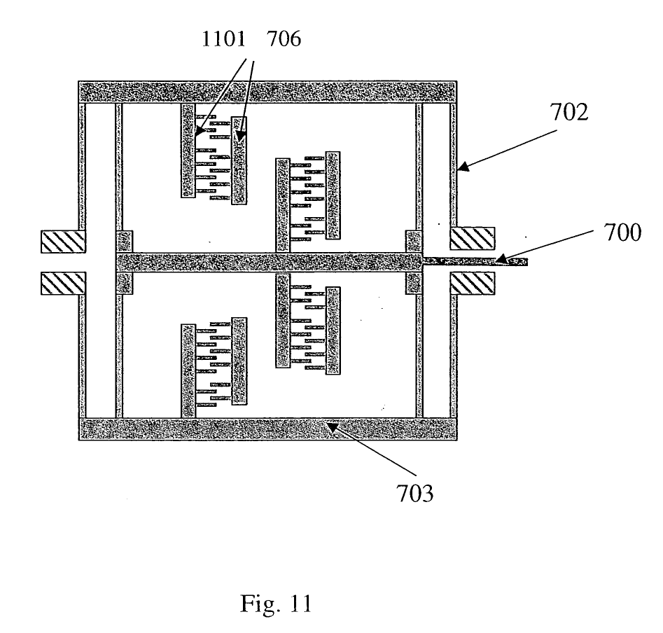

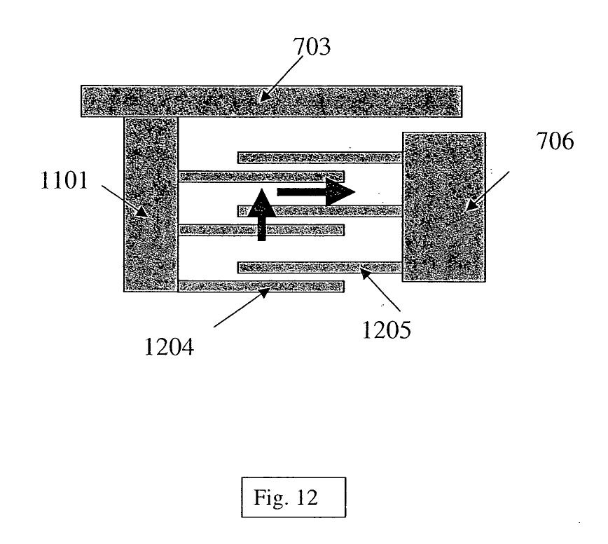

FIG. 11 shows an embodiment of a VOA in which the actuating mechanism comprises additional offset combs. This embodiment is similar to that of FIG. 7, except that one or more sets of moving combs 1101 are connected to frame 703 and a fixed part 706 connected to the substrate. Moving combs 1101 are “offset” from a position symmetrical with respect to fixed combs 706. Moving combs 1101 are rigidly connected to the frame and provide a force in the direction of motion and a stretching force along the spring. Frame 703 moves half the distance of the movement of shutter 700 in the direction of the shutter motion. As a result, the combs attached to the frame can be shorter. As explained in FIG. 12, the offsetting of combs provides the tensile force acting along springs 702 and increases the effective stiffness of the suspension, therefore stabilizing the actuator and improving sensitivity.

FIG. 12 shows the principle of operation of the offset combs in the embodiment of FIG. 11. The design provides an intentional asymmetrical spacing between the fingers of the moving and stationary combs (e.g. between a moving comb finger 1204 and a fixed comb finger 1205 interacting with it), as shown. Due to this asymmetry, offset combs provide a force in a direction perpendicular to shutter motion, in addition to the force in the direction of the shutter motion. This perpendicular force arises since the force acting on each comb is not symmetrical, there being a net force directed toward the closely located stationary comb (FIG. 12). This net force is transferred to frame 703 and then into a stretching force acting along spring 702. The beneficial influence of this stretching force is similar to that discussed with regard to the embodiment incorporating a side electrode in FIG. 9.

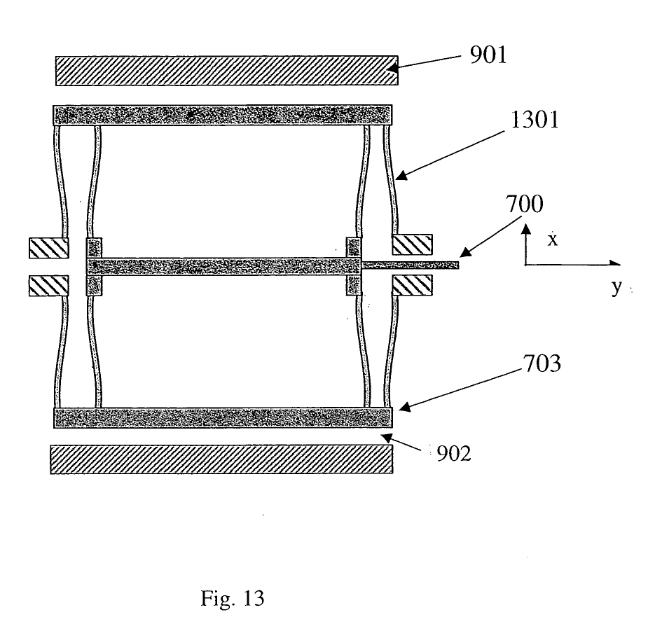

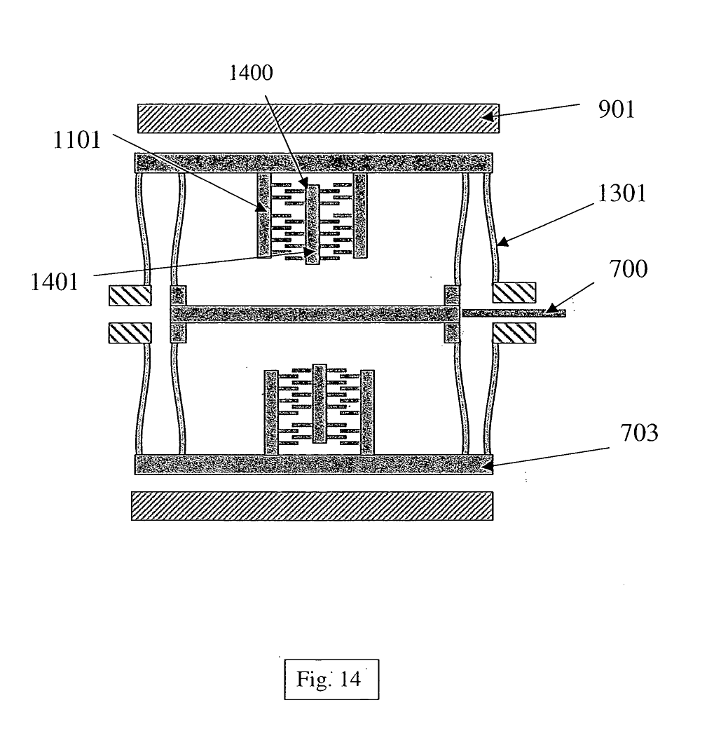

FIG. 13 shows an embodiment of a VOA with an actuating mechanism incorporating an elastic suspension based on the use of pre-curved (bowed) springs connected to a frame. Here, curved springs 1301 replace the straight springs of FIGS. 7-11 and remove the need for comb drives. The curved springs are free to flex above the substrate. This embodiment also comprises a side electrode 901 as in FIG. 9. The actuation is based on the use of the nonlinear coupling between spring axial tension and bending moment on one side, and shutter transverse motion on the other. A deformed curved spring 1301 straightens (elongates by Δₓ) under an axial force in the x direction provided by the electrostatic interaction of side electrodes 901 and frame 703. The straightening translates into a transverse (y-direction) motion Δ_{y} of shutter 700. Due to the nonlinear relation between Δₓ and Δ_{y} (see Eq. (8)), a very small motion of frame 703 toward side electrode 901 leads to a large Δ_{y}. This mode of actuation utilizes the fact that parallel plate actuators are known to be very effective energetically, but limited to small motions. The use of curved springs transforms a small motion of the frame into a large motion of the shutter. The shape of a curved spring can be optimized and can be changed in a very large range in order to achieve a required dependence between the voltage and displacement as well as a low actuation voltage. One advantage of this embodiment is an increase of the spring stiffness in the transverse direction due to the straightening, which results in a close to linear relationship between the actuating voltage and the shutter displacement, or between voltage and attenuation. Another advantage (also due to the increased stiffness) is that the actuator is unconditionally stable and does not exhibit side instability. With no applied actuating forces, the static stiffness of the actuator is high due to the curvature of the springs. This leads to a decrease in the displacements of the actuator under parasitic (for example acceleration) mechanical forces. The actuator is also energetically effective, compact, and has very low mass due to the fact that there is no need for combs, as the actuation is provided solely by side electrode 901.

FIG. 14 shows an embodiment of a VOA as in FIG. 13, with additional offset comb drives 1400. In each such drive a fixed part 1401 is rigidly connected to the substrate, and the moving part (1101) is rigidly connected to frame 703. In the embodiment shown, each offset comb drive has a symmetric structure of two moving parts for each fixed part. Each offset comb drive is built in such a way that it works in the parallel-plate mode when the force between fixed combs 1401 and moving combs 1101 acts in the direction perpendicular to the shutter motion, thereby having an effect similar to the action of side electrode 901. There is no force acting in the direction of the shutter motion since, in contrast with the comb drive actuator, the overlap area between parallel plate electrodes is independent of the actuator motion. The offset comb is used to decrease the actuation voltage through the increase of the effective area of the parallel-plate electrodes. This leads to higher compactness and higher energetic effectiveness (high force per unit area) of the actuator, as well as improved stability.

FIG. 15 shows an embodiment of a VOA with a comb drive actuator comprising at least one damper 1502 that may be either a squeeze film damper, an impact damper, or a combination thereof, the at least one damper used for shortening the VOA switching time. The at least one damper is suspended on (attached to) the main structure (e.g., shutter 700) by elastic springs 1503 (for example bending elements) and interacting with the main structure through a gas (e.g. air) layer 1501

One of the main requirements imposed on a VOA is fast (short) switching time. The main switching time components are (a) the time required to reach the operating point and (b) the time in which mechanical vibrations caused by the transient excitation are attenuated. For typical values of damping, (b) can be relatively large. The artificial increase of the external damping is problematic, especially for the actuators exhibiting large motions. In the case of low frequency or static excitation, the whole structure in FIG. 15 moves as a single body and there is no influence of the additional masses (dampers 1502). In the case of transient excitation, there exists a relative velocity between the main structure and the additional masses. The relative velocity leads to damping forces between the main structure and the dampers, due to the squeeze film damping or impact damping. As a result, the kinetic energy of the main structure is transferred partially to the kinetic energy of dampers 1502 and then dissipated. In order to decrease the overall mass of the actuator, the mass of frame 703 can be used as an additional mass, allowing placement of low weight elements for the squeeze film/impact coupling to the main structure.

Locking Mechanism for VOA

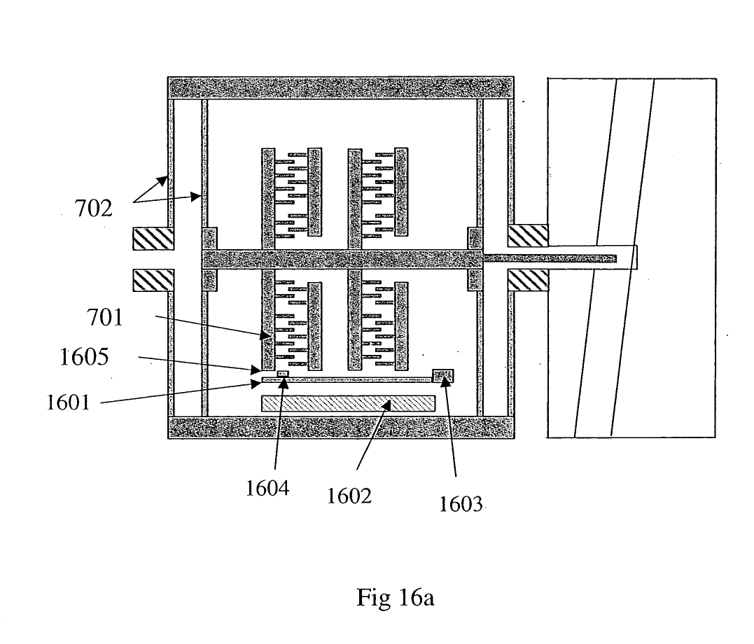

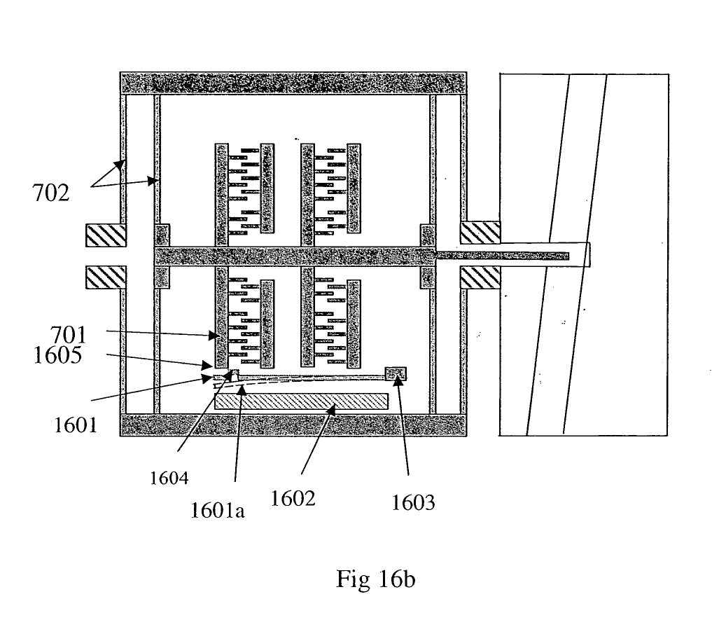

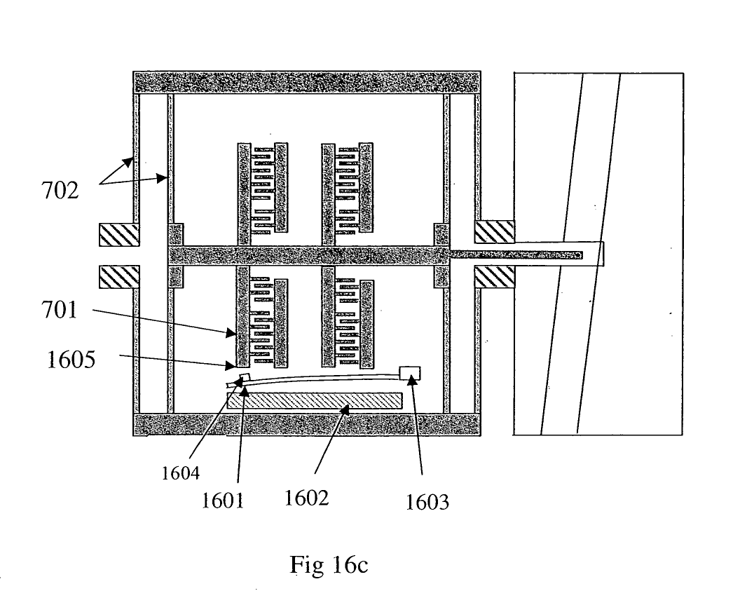

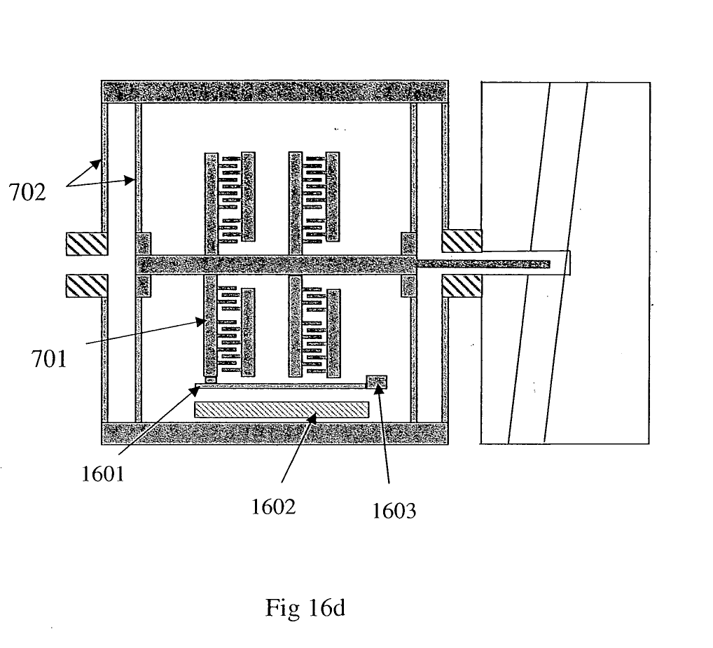

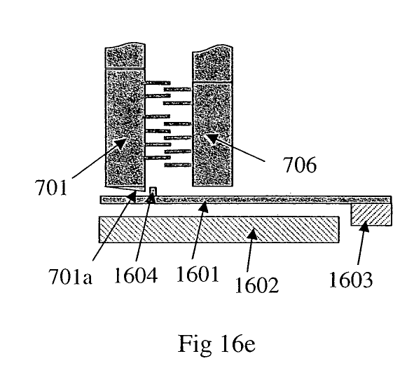

The locking mechanism disclosed herein is designed to hold the shutter in its place after activation (i.e. the driving force of the combs/system is disabled). One possible point for holding the shutter is an edge of the moving comb (rotor) of the drive, the moving comb being rigidly connected to the shutter. An exemplary locking mechanism and its activation are described in FIGS. 16a-16e. The locking mechanism comprises at least one locking spring 1601 having an electrode 1603 and a bulge 1604, and a pulling electrode 1602. Locking spring 1601 can engage through bulge 1604 an edge 1605 of moving comb 701. Edge 1605 is preferably sloped with a slope 701a, FIG. 16e to provide an increased holding force opposing the retaining force of main VOA springs 702. More than one locking mechanism can be used per comb. Locking mechanisms can also be positioned and used with comb edges sloped in an opposite direction to ensure bi-directional lock.

In operation, in FIG. 16a, the locking mechanism is not engaged, and the VOA is un-actuated. In FIG. 16b, spring 1601 is pulled (downwards in the figure) by electrode 1602 to a pulled position 1601a, while the VOA is still un-actuated. In FIG. 16c, with spring 1601 in the pulled position, moving comb 701 (rotor) is actuated, moving to the right so that edge 1605 essentially overlaps bulge 1604, bringing the VOA to an actuated but still unlocked state. In FIG. 16d, spring 1601 is “released” and returned to its initial position, with bulge 1604 now pressing against edge 1605 of comb 701 and holding it in place, locking the VOA. FIG. 16e shows in more detail the situation in (a). It is clear from this figure that once engaged by the locking mechanism, moving comb 701 is prevented from returning to its initial position (to the right).

High Resolution Radial-to-Linear (RTL) Actuator for VOA

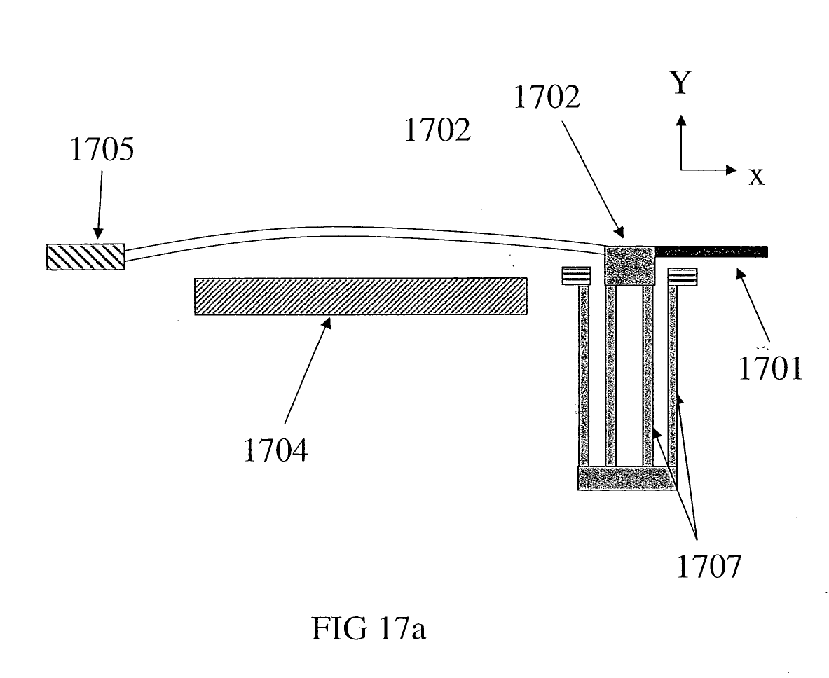

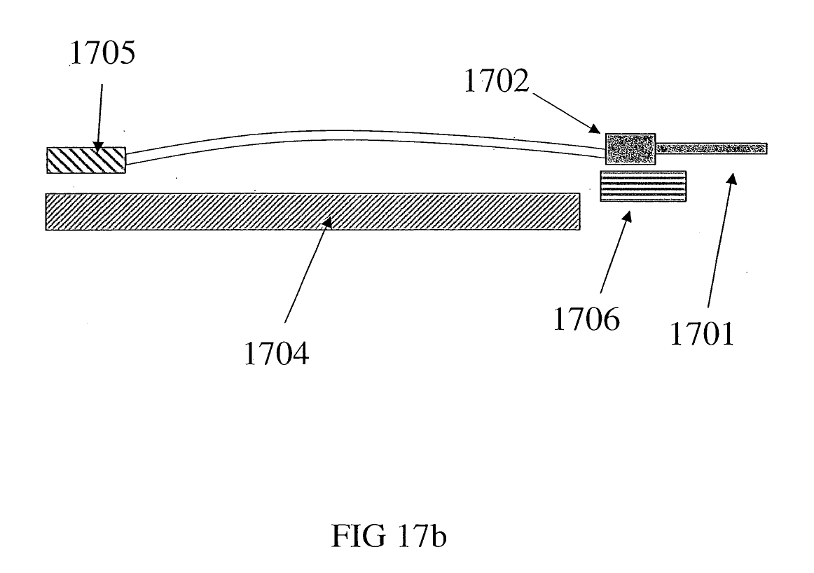

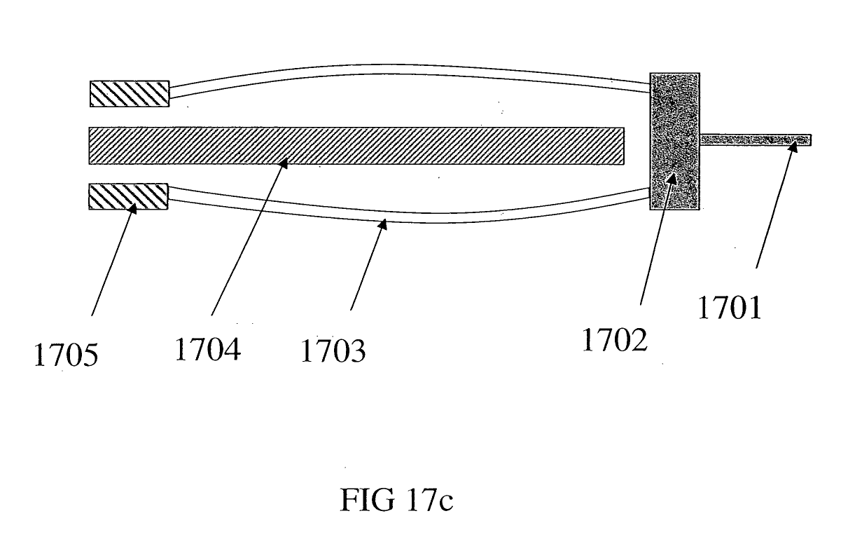

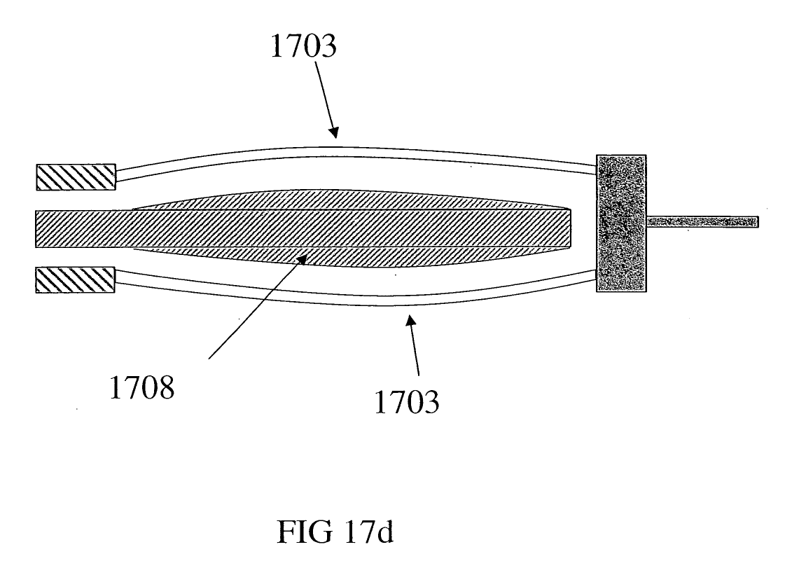

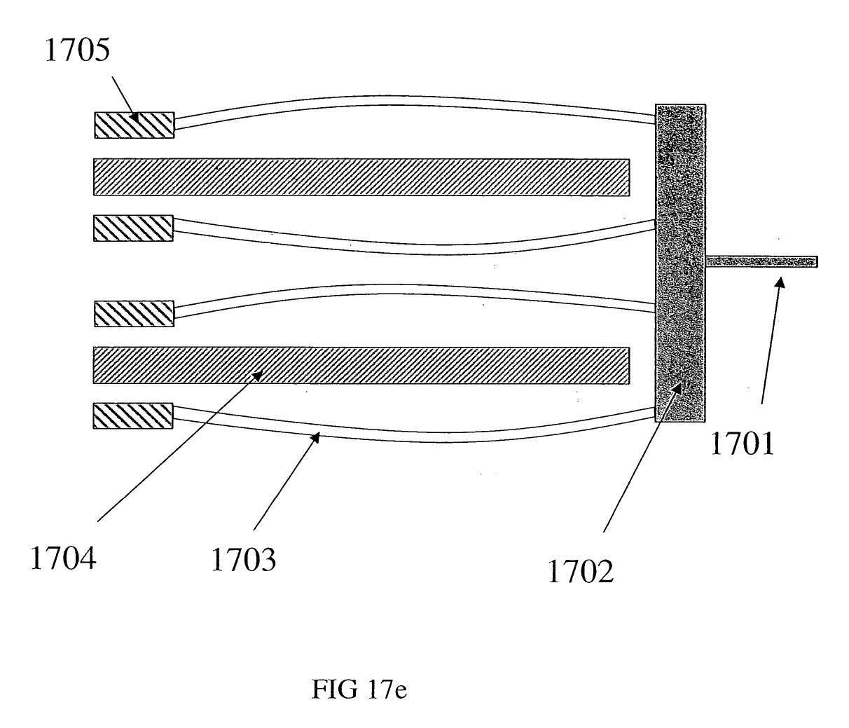

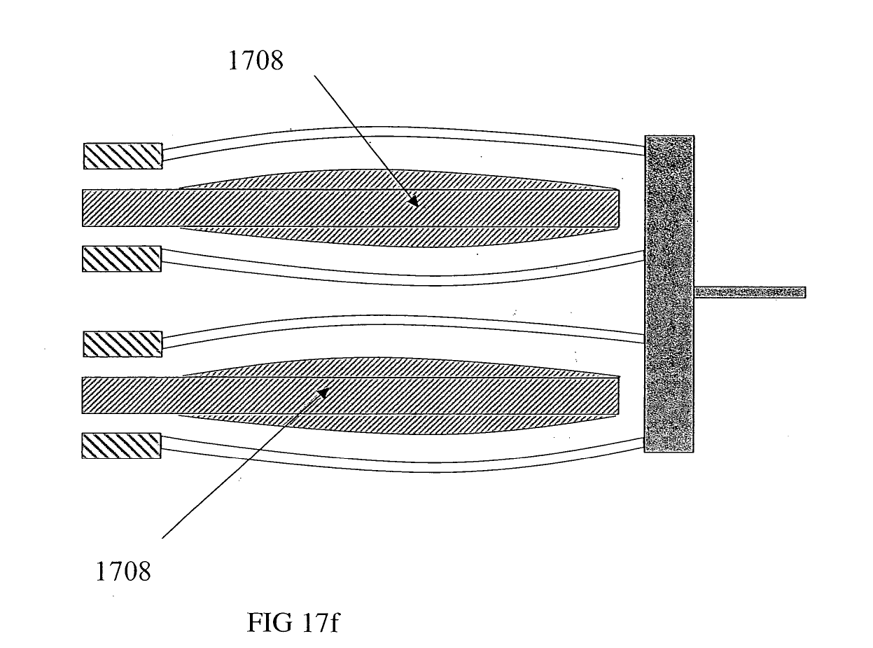

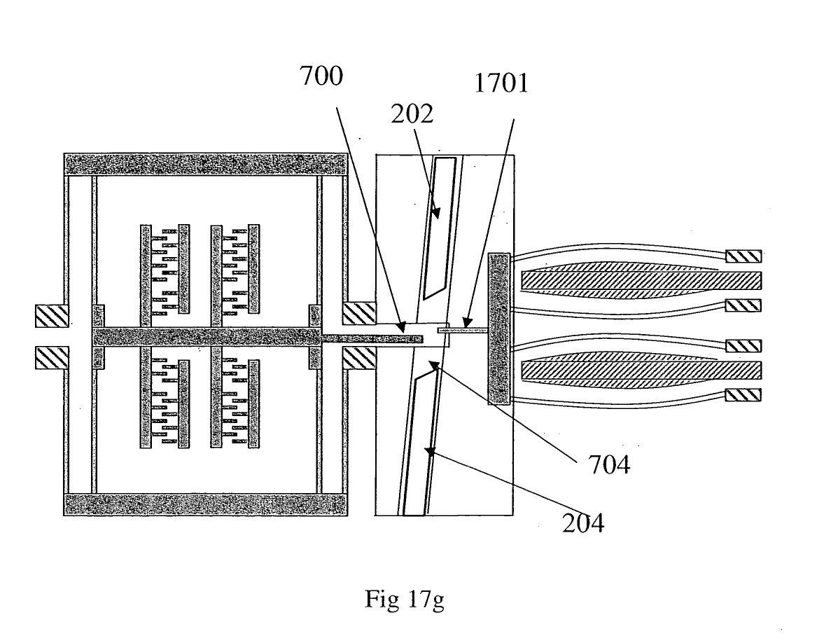

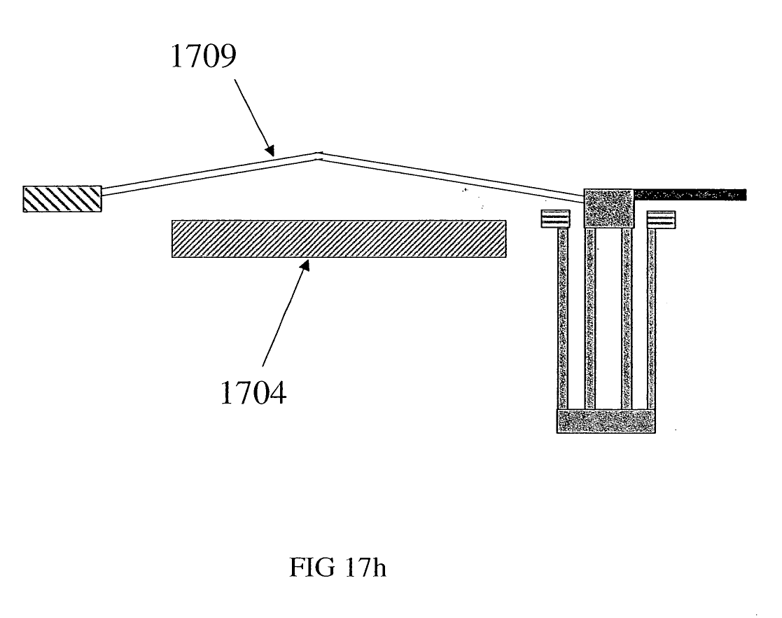

FIG. 17 shows an embodiment of a high-resolution radial-to-linear (RTL) actuator for VOA according to the present invention. This actuator transforms a radial movement of a curved spring beam into a much smaller movement in a linear (tangential) direction. The actuator is comprised of at least one curved spring 1703 (FIG. 17a) that can function as a spring electrode and which is rigidly attached at one end 1705 to the substrate. Electrostatic pulling of spring electrode 1703 towards a fixed electrode 1704 (−Y direction-radial) causes the right end of spring electrode 1703 to move perpendicular to the pulling force in the X direction (tangential-linear). A frame 1702 attached to beam springs 1707 and to a shutter 1701 is constrained by the beam springs to move in the X direction and is guiding the movement of the spring electrode and the shutter attached to it in that direction. The relationship between the X direction/Y direction motions is Δx=3(Δy)²/5L, where L is the spring length. FIG. 17b shows an embodiment as in FIG. 17a in which frame 1702 can slide on a fixed guide 1706 that constrains it to move to the X direction, thus guiding the movement of spring electrode 1703 and the shutter attached to it in that direction. A slight electrostatic force can preload the spring electrode to contact fixed guide 1706 before starting the linear movement. FIG. 17c shows an embodiment like in FIG. 17b without fixed guide 1706, having instead a symmetric second spring electrode 1703, with a frame 1702 connecting the two spring electrodes and shutter 1701. An electrostatic force between fixed electrode 1704 and the two spring electrodes will pull the spring electrodes to the fixed electrode (radial-Y direction) and cause the free ends of the spring electrodes, the frame and the shutter to move in vertical (linear X) direction.

FIG. 17d shows an embodiment like the one in FIG. 17c with an optimized fixed electrode 1708 instead of electrode 1704. In this configuration, entire spring electrode 1703 is close to the pulling fixed electrode. FIG. 17e shows an embodiment like in FIG. 17c, with a symmetric second pair of spring electrodes 1703 and a fixed electrode 1704. Frame 1702 connects the four spring electrodes and shutter 1701. The action is like in FIG. 17c but the whole actuator is more rigid. FIG. 17f shows an embodiment like in FIG. 17e but with optimized fixed electrodes 1708 as described in FIG. 17d. FIG. 17g shows an embodiment of a VOA with one frame-driven actuator as in FIG. 7 and one high resolution radial-to-linear (RTL) actuator as in FIG. 17f, driving two shutters from opposite sides. By using two opposing (facing each other) VOAs (shutters 700 and 1701) each one with a different movement resolution, one can activate the shutter in both resolutions, achieving longer (rougher) movement with the frame-driven actuator and shorter (fine) movement with the high-resolution RTL actuator.

FIG. 17h shows an embodiment like in FIG. 17a in which curved spring electrode 1703 is substituted with a bent beam spring 1709. The functionality of this embodiment is very similar to that of the embodiment of FIG. 17a. Finally, we note that a bent spring can replace a curved spring in each embodiment employing such a curved spring described herein.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made. In particular, it is emphasized that the various embodiments of the actuating mechanism of the present invention may be connected and applied equally well to other types of shutters, in particular blocking shutters, to provide VOAs with improved properties over prior art.

What is claimed is:

1. A MEMS variable optical attenuator (VOA) comprising:
a. at least one semitransparent refraction-mode shutter operative to attenuate an optical beam transmitted along an optical path from a first optical fiber to a second optical fiber, using refraction of said beam; and
b. an actuator operative to position said at least one shutter in said optical path along a movement axis.

2. The MEMS VOA of claim 1, wherein each fiber ends in an angled facet, wherein said position includes a position in which said movement axis is parallel to said facets, wherein said at least one shutter includes a first sidewall and a second sidewall, said second sidewall having a plurality of sections forming each a different angle with said first sidewall, and wherein said refraction is determined by each said angle.

3. The MEMS VOA of claim 1, wherein said at least one shutter includes two shutters.

4. The MEMS VOA of claim 1, wherein said actuator includes at least one comb drive.

5. The MEMS VOA of claim 1, wherein said actuator includes a frame with a plurality of springs, at least one of said springs connected to said at least one shutter.

6. The MEMS VOA of claim 5, wherein said at least one spring is straight.

7. The VOA of claim 5, wherein said at least one spring is selected from the group consisting of a curved spring and a bent spring.

8. The MEMS VOA of claim 5, wherein said actuator further includes at least one comb drive.

9. The MEMS VOA of claim 5, wherein said shutter is serpentine-shaped.

10. The MEMS VOA of claim 6, wherein said actuator further includes at least one side electrode interacting electrostatically with said frame.

11. The MEMS VOA of claim 7, wherein said actuator further includes at least one side electrode interacting electrostatically with said frame.

12. The MEMS VOA of claim 6, wherein said actuator further includes at least one offset comb drive.

13. The MEMS VOA of claim 7, wherein said actuator further includes at least one offset comb drive.

14. The MEMS VOA of claim 13, wherein said at least one offset comb drive is symmetrical.

15. The MEMS VOA of claim 1, further comprising at least one damper selected from the group consisting of a squeeze film damper, an impact damper, and a combination thereof, said at least one damper connected to said at least one shutter and used for shortening a VOA switching time.

16. The MEMS VOA of claim 1, further comprising at least one locking mechanism used to hold said at least one shutter in a locked position after actuation.

17. The MEMS VOA of claim 7, wherein said actuator is a high resolution radial-to-linear (RTL) actuator operative to translate a radial movement of said curved spring into a much smaller linear movement along said movement axis.

18. The MEMS VOA of claim 1, wherein said shutter is vertical.

19. The MEMS VOA of claim 17, further comprising a side electrode interacting electrostatically with said curved spring to provide said operability.

20. A variable optical attenuator comprising:
a. a transparent silicon shutter having two, a first and a second, non-parallel shutter sidewalls, each said sidewall having an arbitrary shape, said shutter operative to attenuate an optical beam transmitted along an optical path from a transmitting fiber having a transmitting optical axis and facing said first shutter sidewall to a receiving fiber having a receiving optical axis and facing said second shutter sidewall, wherein said attenuation is based on a tilt induced by a variable angle between said two non-parallel shutter sidewalls, said variable angle dependent on a position of said shutter relative to said beam; and
b. an actuating mechanism for positioning said shutter in said optical path.

21. The variable optical attenuator of claim 20, wherein said shape is a wedge shape with a narrow top and a wider bottom, said wedge shape formed by a plurality of trapezium cross-sections with first and second trapezium sidewalls, said first trapezium sidewalls forming said first shutter sidewall and said second trapezium sidewalls forming said second shutter sidewall.

22. The variable optical attenuator of claim 21, wherein each said transmitting and receiving fiber ends in a fiber facet angled relative to its respective optical axis, and wherein said actuator mechanism includes an electrostatically driven actuator that displaces mechanically said shutter in a direction substantially parallel to said fiber facets.

23. The variable optical attenuator of claim 22, wherein said first shutter sidewall is positioned at a first angle relative to said transmitting fiber facet, and wherein said second shutter sidewall is positioned at a second angle different from said first angle relative to said receiving fiber facet.

24. The variable optical attenuator of claim 20, wherein said attenuation includes beam refraction at each said sidewall.

25. The variable optical attenuator of claim 20, implemented in a silicon-on-insulator (SOI) substrate having an active layer and a handle layer, wherein said silicon shutter and said actuating mechanism are built in said active layer, and wherein said fibers are positioned in V-grooves etched in said handle layer.

26. A MEMS variable optical attenuator (VOA) characterized by a switching time comprising:
a. at least one semitransparent refraction-mode shutter having a wedge shape and operative to attenuate an optical beam transmitted along an optical path from a first optical fiber to a second optical fiber, using refraction of said beam;
b. an actuator operative to position said at least one semitransparent refraction-mode shutter to intersect said optical path; and
c. at least one damper selected from the group consisting of a squeeze film damper, an impact damper, and a combination thereof, said at least one damper connected to said at least one shutter and used for shortening the VOA switching time.

27. A MEMS variable optical attenuator (VOA) comprising:
a. at least one semitransparent refraction-mode shutter having a wedge shape and operative to attenuate an optical beam transmitted along an optical path from a first optical fiber to a second optical fiber using refraction of said beam;
b. an actuator operative to position said at least one semitransparent refraction-mode shutter to intersect said optical path; and
c. a locking mechanism for locking said shutter in an actuated position.

28. An integrated variable optical attenuator and 2×2 optical switch component comprising:
a. four tapered and angled optical fibers arranged as two transmitting and two receiving fibers in a butt-coupling setup; and
b. a MEMS element operative to perform both switching and variable optical attenuation of an optical beam transmitted along an optical axis between one of said transmitting fibers to one of said receiving fibers.

29. The integrated component of claim 28, wherein said MEMS element includes a blocking type triangular shutter having an opening therein, said opening allowing said optical beam un-attenuated transmission when properly aligned with said optical axis.

30. A MEMS variable optical attenuator (VOA) comprising:
a. a shutter operative to attenuate an optical beam transmitted along an optical path from a first optical fiber to a second optical fiber;
b. an actuator operative to position said at least one shutter to intersect said optical path, said actuator including a folded suspension having a plurality of springs, at least one of said springs connected to said at least one shutter, wherein said springs are selected from the group consisting of curved springs and bent springs.

31. The MEMS VOA of claim 30, wherein said actuator further includes at least one comb drive.

32. The MEMS VOA of claim 30, wherein said shutter is serpentine-shaped.

33. A MEMS variable optical attenuator (VOA) comprising:
a. a shutter operative to attenuate an optical beam transmitted along an optical path from a first optical fiber to a second optical fiber;
b. an actuator operative to position said at least one shutter to intersect said optical path, wherein said actuator includes:
i. a folded suspension having a plurality of springs, at least one of said springs connected to said at least one shutter; and
ii. at least one side electrode interacting electrostatically with said frame.

34. The MEMS VOA of claim 33, wherein said actuator further includes at least one offset comb drive.

35. The MEMS VOA of claim 34, wherein said at least one offset comb drive is symmetrical.

36. The MEMS VOA of claim 33, further comprising at least one damper selected from the group consisting of a squeeze film damper, an impact damper, and a combination thereof, said at least one damper connected to said at least one shutter and used for shortening a VOA switching time.

37. The MEMS VOA of claim 33, further comprising at least one locking mechanism used to hold said at least one shutter in a locked position after actuation.

38. The MEMS VOA of claim 33, wherein said shutter is vertical.

39. A MEMS variable optical attenuator (VOA) comprising:
a. a shutter operative to attenuate an optical beam transmitted along an optical path from a first optical fiber to a second optical fiber; and
b. a high resolution radial-to-linear (RTL) actuator having at least one pre-curved spring connected to said shutter, said actuator operative to translate a radial movement of said pre-curved spring into a much smaller movement that positions said shutter to intersect said optical path.

40. The MEMS VOA of claim 39, further comprising a side electrode interacting electrostatically with said curved spring to provide said operability.
